(19) United States
(12) Patent Application Publication
(10) Pub. No.: US 2011/0292371 A1
(43) Pub. Date: Dec. 1, 2011

(54) Method and Apparatus for a Pulsed Coherent Laser Range Finder

(75) Inventor: Chia Chen CHANG, Gaithersburg, MD (US)

(73) Assignee: Optical Air Data Systems, LLC, Manassas, VA (US)

(21) Appl. No.: 13/116,621

(22) Filed: May 26, 2011

Related U.S. Application Data
(60) Provisional application No. 61/349,407, filed on May 28, 2010.

(51) Int. Cl. G01C 3/08; G01P 3/36

(52) U.S. Cl. 356/5.01; 356/28

(57) ABSTRACT

Systems and methods are disclosed for measuring a distance, a velocity, etc., of a target using coherent laser radiation. In one example, a method is provided comprising measuring a time required for a light pulse to travel to and from a target, the light pulse reflecting from the target, and determining the distance to the target based on the measuring. The method also comprises measuring a Doppler shift of the reflected light pulse using an optical detection technique and determining the velocity of the target from the Doppler shift. In a further example, a system is disclosed comprising a transceiver, a coherent source, an optical system and a detector configured to measure the distance to the target based on a measured time for a light pulse to travel to and from the target. The system is also configured to determine the velocity of the target from a measured Doppler shift.

### CROSS REFERENCE TO RELATED APPLICATIONS

The present application claims benefit under 35 U.S.C §119(e) to U.S. Provisional Patent Application No. 61/349,407 filed May 28, 2010, which is incorporated by reference herein in its entirety.

### BACKGROUND

1. Field of the Invention

This disclosure relates to systems and methods for measuring the distance, velocity, or the like of an object at long or short ranges using optical coherence detection.

2. Background Art

LIDAR (light detection and ranging) is a technique to measure displacement, range or velocity of a target. Among LIDAR techniques, a laser range finder (LRF) can be used for distance metrology. Various existing techniques can be categorized in terms of three operation principles: interferometry, triangulation and time-of-flight (TOF).

The various techniques have complementary attributes in terms of their ability to measure distances and velocities at short and long ranges. With interferometric schemes, for example, high accuracy can be achieved, but absolute distance measurements can only be made for centimeter order distances. The maximum range is limited by the laser coherence length and resolution decreases as the measured distance increases. Systems based on triangulation use the relative locations of the emitted light source, target, and detector to provide several meters order distance measurement with centimeter order resolution. Time of flight systems are suitable for measuring longer distances but require complex apparatus and delicate requirements for synchronization between emitted and received pulses. A number of techniques exist for determining velocities based on measuring Doppler shifts but are not suitable for measuring distances.

Very few techniques exist for measuring both distance and velocities wherein both shot and long distances can be measured with high accuracy. The only existing techniques for measuring both distance and velocity utilize electronic coherent detection and involve delicate measurements of relative phases between a reflected pulse and a reference beam. As such, these systems require complex apparatus that are error prone and difficult to maintain.

### SUMMARY

Therefore, what is needed is a system and method to measure distances, velocities, etc., for example to substantially simultaneously measuring distance and velocity, with high accuracy at close and long ranges using optical coherence techniques. For example, the system and method substantially eliminate the need to measure delicate phase information. The disclosed systems and methods are also robust to effects due to phase noise.

In one embodiment of the present invention, a method is provided comprising measuring a time required for a light pulse to travel to and from a target, the light pulse reflecting from the target, determining a distance to the target based on the measuring, measuring a Doppler shift of the reflected light pulse using an optical detection technique, and determining a velocity of the target from the Doppler shift.

In another embodiment of the present invention, a system is provided comprising a transceiver, an optical system, and a detector. The transceiver is configured to receive a light pulse from a coherent source, transmit the light pulse to reflect from a target, and receive the reflected light pulse. The optical system is configured to receive the reflected light pulse and a reference light beam and to measure a Doppler shift of the reflected light pulse with respect to the reference light beam. The detector is configured to measure a time for the light pulse to travel to and from the target and to determine a distance to the target based on the measured time, and to determine a velocity of the target from the Doppler shift.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 illustrates a system to measure characteristics of a target, according to an embodiment of the present invention.

FIG. 2 illustrates a radiation source, according to an embodiment of the present invention.

FIGS. 3A and 3B illustrate embodiments of an optical transceiver, according to various embodiments of the present invention.

FIGS. 4A and 4B illustrate embodiments of an optical system, according to various embodiments of the present invention.

FIG. 5 illustrates a detector, according to an embodiment of the present invention.

FIG. 6 illustrates a transmitted and reflected pulse, according to an embodiment of the present invention.

FIGS. 7A and 7B illustrate a simulation of phase uncertainty of a light pulse, according to various embodiments of the present invention.

FIGS. 8A and 8B illustrate the notion of extracting information from a pulse that contains random noise, according to various embodiments of the present invention.

FIGS. 9A and 9B illustrate using a temporal standard deviation approach to extract information from a pulse comprising a plurality of pulses, according to various embodiments of the present invention.

FIGS. 10 and 11 illustrate a flowchart describing methods, according to various embodiments of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

The present invention is directed to a method and apparatus for a pulsed coherent laser range finder. This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment,” “an embodiment,” “an example embodiment,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

Before describing such embodiments in more detail, however, it is instructive to present an example environment in which embodiments of the present invention may be implemented.

In one embodiment a pulsed coherent laser range finder (“LRF”) may be used to determine distance and relative velocity of solid, liquid, or gaseous objects. Such a device is sometimes also called a laser Doppler velocimeter (“LDV”). An LRF can be used to determine wind velocities, as well as to determine distances to and velocities of solid objects. In one embodiment, an LRF can be used on an aircraft to determine the distance and relative velocity of the aircraft with respect to the ground. As an example, a helicopter can use an LRF to safely land in low visibility weather or dust conditions.

A wind speed LRF transmits a light pulse to a target region (e.g., into the atmosphere) and receives a portion of that light that is scattered or reflected back. In atmospheric measurements, the target for this reflection consists of entrained aerosols (resulting in Mie scattering) or the air molecules themselves (resulting in Rayleigh scattering). Using the received portion of scattered or reflected light, the LRF determines a velocity of the target relative to the LRF.

In one example, a wind speed LRF can include a coherent source, a transceiver an optical system and a detector. The coherent source and transceiver can further comprise a beam shaper and one or more optical elements (e.g., telescopes). The optical elements project a light pulse into the target region. The light pulse strikes airborne scatterers (or air molecules) in the target region, resulting in a back-reflected or backscattered light pulse. In a mono-static configuration, a portion of the backscattered light pulse is collected by the same optical elements that transmitted the light pulse. The reflected light pulse is combined with a reference beam in order to detect a Doppler frequency shift from which a velocity can be determined. The combining me be made using optical homodyne or heterodyne techniques.

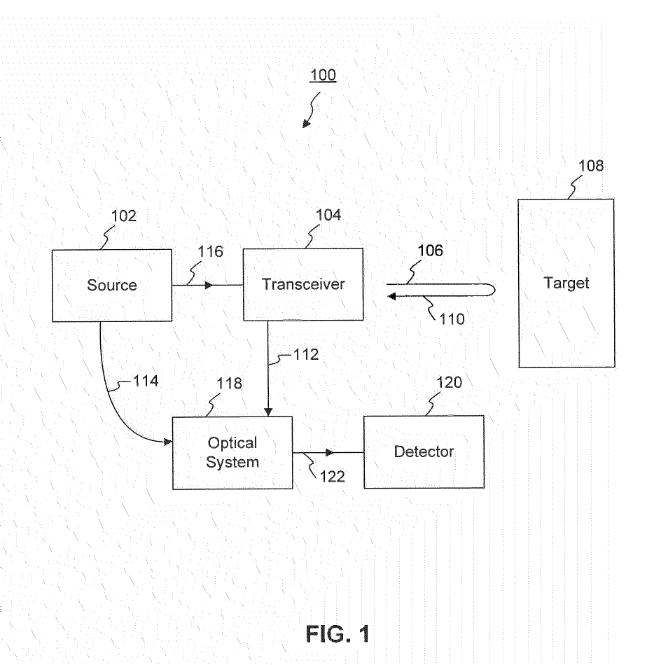

FIG. 1 illustrates a system 100 according to an embodiment of the present invention. In this example, system 100 comprises a source of radiation 102, a transceiver 104, a target region 108, an optical system 118, and a detector 120. The source of radiation 102 can be a coherent source. The transceiver 104 can be configured to receive a light pulse from the source 102, transmit the light pulse 106 to reflect from a target 108, and receive the reflected light pulse 110. The detector 120 can be a PIN photodetector.

In this example, optical system 118 can be configured to receive the reflected light pulse that travels along optical path 112 and a reference light beam that travels along optical path 114. Comparing of the reference and reflected light beams allows for measuring a Doppler shift of the reflected light pulse with respect to the reference light beam.

In this example, a detector 120 is configured to measure a time for the light pulse to travel to 106 and from 110 the target and to determine a distance to the target based on the measured time. Detector 120 is also configured to determine a velocity of the target from the Doppler shift.

In one example, one or more optical paths can comprise optical waveguides, e.g., optical fibers. For example, light propagates from the source 102 to the transceiver 104 along optical path 116, and to the optical system 118 along optical path 114, from the transceiver 104 to the optical system 118 along optical path 112, and from the optical system 118 to the detector 120 along optical path 122 via respective optical fibers. In a further example, optical paths 116, 114, 112 and 122 may be in free space.

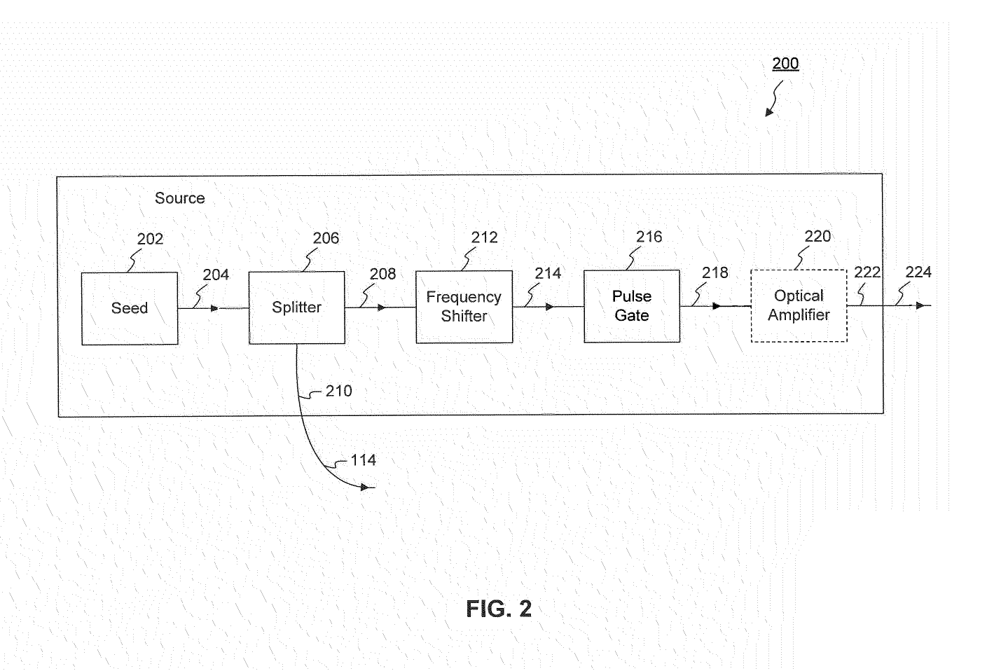

FIG. 2 illustrates an embodiment of a source 200. For example, source 200 may be a coherent source of radiation 200. In this example, the source may comprise a seed laser 202, an optical splitter 206, a frequency shifter 212, a pulse gate 216, and optionally an optical amplifier 220.

In one example, light propagates through the various subsystems via optical paths 204, 208, 214, 218, 222 and 210. Optical paths 204, 208, 214, 218, 222, and 210 may comprise optical waveguides, e.g., optical fibers, or can be in free space. All optical paths in the following disclosed embodiments can be either in free space or carried by optical waveguides or fibers.

The seed 202 may be a coherent source of light, such as a CW laser operating at an optical carrier frequency ωₛ. A beam splitter 206 can be configured to split off a portion of a light beam from seed 202 as a reference beam 210, which can be carried by an optical fiber. A primary beam from splitter 206 propagates along path 208 to frequency shifter 212.

Frequency shifter 212 can shift the frequency of the primary beam to a second frequency ω_{fs}. In an example, the frequency shifter 212 can be an acousto optic modulator (AOM) that is used to provide a frequency shift with respect to the optical carrier frequency ωₛ. The frequency shifted beam traveling along optical path 214 is carried to the pulse gate 216.

In one example, the pulse gate 216 may be an AOM. In other embodiments, the pulse gate 216 can be an electro-optic Mach-Zehnder intensity modulator with a picosecond-order switching time. In further embodiments, the pulse gate 216 can be a semiconductor optical amplifier (SOA) with a nanosecond-order switching time.

In one example, source 200 can also include an optional optical amplifier 220. The optical amplifier can include one or multiple stages, depending on the optical power requirements. The amplifier 220 may be limited by stimulated Brillouin scattering. In an example, optical amplifier 220 can be a telecom grade erbium doped fiber amplifier with a single mode pump. An Er—Yb co-doped double clad gain fiber with a multi-mode pump can also be used.

In one example, source 200 provides an output pulse traveling along optical path 224 with frequency ω_{fs} that is shifted relative to the optical carrier frequency ωₛ of the seed 202. Source 200 can also provide a reference beam traveling along optical path 114 that propagates along path 210 within the source 200.

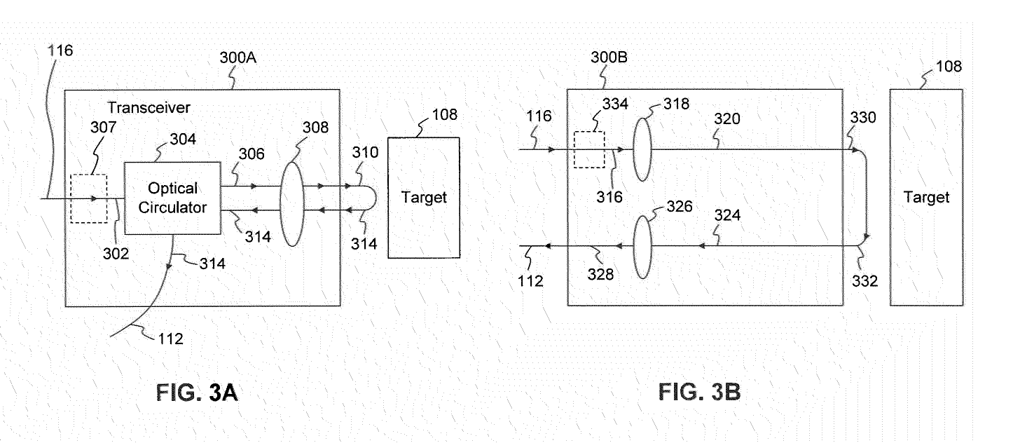

Example embodiments for a transceiver are shown as systems 300A and 300B in FIGS. 3A and 3B respectively. For example, either one of system 300A or 3008 can be used for transceiver 104 in FIG. 1.

System 300A is an example mono-static optical transceiver. In a mono-static transceiver, a portion of the backscattered light pulse is collected by the same optical elements that transmitted the light pulse.

In one example, mono-static transceiver 300A receives a light pulse along path 302 that enters transceiver along light path 116. The light pulse travels may have a frequency ω_{fs}. The light pulse is transmitted to an optical circulator 304 along optical path 302. Optical circulator 304 transmits the pulse along path 306 through mono-static lens 308 as light pulse 310 to and from a target region 108. Some of the light incident on the target region 108 is reflected back as reflected pulse 314 through lens 308 to optical circulator 304.

In one example, an optional optical amplifier 307 is included in the transceiver and positioned before the optical circulator 304 and lens 308. Amplifier 307 can be used to increase the intensity of the transmitted signal to ensure the reflected light pulse has sufficient intensity to be detected.

In one example, optical circulator 304 directs reflected beam 314 along path 112, as discussed in more detail in FIG. 1.

In one example, bi-static transceiver 300B is illustrated in FIG. 3B.

In a bi-static transceiver, a portion of the backscattered beam is collected by a different set of optical elements than those used to transmit the light pulse. One lens 318 is used to transmit the light pulse and another lens 326 is used to collect reflected light from the target.

In this embodiment, a light pulse travels from a source to the transceiver along optical path 116. Inside the transceiver, the light pulse travels to the transmitting lens 318 along optical path 316. After being focused by lens 318, the light pulse travels along optical path 320. The optical pulse can also be amplified by an optional optical amplifier 334 before encountering the lens 318. The optical amplifier can be used to increase the intensity of the transmitted light pulse to ensure the reflected light pulse has sufficient intensity to be detected. The transceiver emits a transmitted light pulse 330 that travels to a target region 108. Part of the pulse is reflected back from the target and travels along optical path 332. The reflected pulse generally has frequency ω_{fs+dp} that is different from the incident light pulse due to the Doppler shift. The Doppler shift occurs due to motion of the target. The reflected pulse is collected by receiver lens 326 and is transmitted along optical path 328. The reflected pulse emerges from the transceiver along optical path 112.

The reflected light beam traveling along optical path 112 also includes a component with frequency ω_{fs} that results from a portion of the incident light pulse being reflected from the optical components of the transceiver. Thus, in general, the reflected beam contains two pulse-like features. One feature has frequency ω_{fs} and occurs at a first time instant corresponding to the incident light pulse having been reflected from the transceiver optics. The second pulse-like feature occurs at a second time instant and has frequency ω_{fs+dp} resulting from the light pulse reflecting from the target region and returning to the transceiver. The time difference between the second time instant and the first time instant is a measure of the time for the pulse to propagate to and from the target. This time difference gives a measure of the relative distance between the transceiver and the target as discussed below.

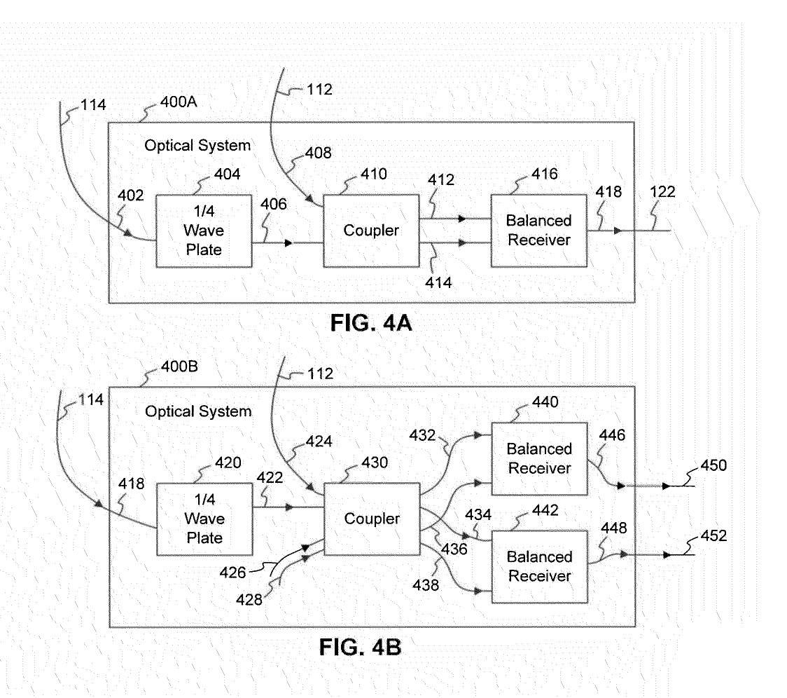

FIGS. 4A and 4B illustrate embodiments of optical systems 400A and 400B. For example, optical systems 400A or 400B can be used for optical system 118 in FIG. 1. Optical systems 400A and 400B are configured to receive a reflected light pulse having two components. These components comprise one with frequency ω_{fs} occurring at a first time instant, and another occurring at a second time instant with frequency ω_{fs+dp}. Optical systems 400A and 400B also receive a reference light beam traveling having frequency ωₛ. The reference light beam can be a CW laser beam. Optical systems 400A and 400B can be configured to measure a Doppler shift of the reflected light pulse with respect to the reference light beam. Combining the reflected light pulse with the reference light beam generates a combined light beam having two pulse-like components: one with frequency ω_{fs}−ωₛ occurring at a first time instant, and another with frequency ω_{fs+dp}−ωₛ occurring at a second time instant. This information is sufficient to determine the Doppler shift frequency ω_{fs+dp}−ω_{fs} by subtracting the frequencies of the two pulse-like features of the combined light beam.

In one example, system 400A comprises a polarizer 404 (e.g., a quarter wave plate), an m×n optical coupler 410 (e.g., a 2×2 coupler), and a receiver 416 (e.g., a balanced receiver). The 2×2 optical coupler 410 can be an optical fiber coupler. The 2×2 optical coupler 410 takes as input the reference beam traveling along optical path 114 and the reflected light beam traveling along optical path 112. The reference beam travels to the quarter-wave plate 404 by optical path 402. The reflected light beam travels to the 2×2 coupler by optical path 408. The quarter-wave plate 404 is placed in the path of the reference beam to split and retard the linearly polarized light components of the reference beam. The quarter-wave plate 404 converts linearly polarized light into circularly polarized light. The resulting circularly polarized light is then mixed with a reflected light pulse. The quarter-wave plate 404 can be rotated to maximize the mixing efficiency between the reference beam and the reflected beam.

The circularly polarized light that leaves the quarter-wave plate 404 travels along light path 406 and is feed into the 2×2 coupler 410. The 2×2 coupler 410 is used to mix the reference beam and the reflected beam to generate a combined light beam having two components, as discussed above. Coupler 410 outputs signals 412 and 414, which have the same optical frequency components, but have a relative 180° phase difference. Both signals 412 and 414 are fed into balanced receiver 416.

In an example, 2×2 optical coupler 410 can be a 3 dB coupler. As such, both signals 412 and 414 have their signal power split in half.

In an example, the 2×2 optical coupler 410 can be a 3 dB fiber optic coupler.

In one example, balanced receiver 416 is used to remove the DC component of the combined light beam. Balanced receiver 416 outputs a combined light beam having two frequency components, as discussed above. The combined light beam is carried along optical path 418 and emerges from the optical system along optical path 122.

FIG. 4B illustrates an embodiment optical system 400B that enables the removal of phase ambiguity and the effects of phase noise from the combined light beam. Optical system 400B can be used for optical system 118 in FIG. 1. In this embodiment, optical system 400B has the following components: a quarter-wave plate 420, an optical coupler 430 (e.g. a 4×4 coupler), and two balanced receivers 440 and 442. System 400B takes a reference light beam as input. It also takes the reflected light pulse traveling along optical path 112. The reference signal is transmitted to the quarter-wave plate 420 along optical path 418. The action of the quarter-wave plate 420 is to convert linearly polarized light components of the reference light beam into circularly polarized light for better mixing between the reference signal 414 and the reflected light pulse.

The 4×4 coupler 430 has four inputs. The reflected light pulse travels along optical path 424 and is input to the 4×4 coupler as shown. The reference beam travels along optical path 422 and is input as shown. The other two inputs to the 4×4 coupler 426 and 428 are not needed for this embodiment. The four outputs of the 4×4 coupler each have a 90° phase difference relative to one another. The action of the 4×4 coupler 430 is to take the reference beam, and split it into two split reference beams having a relative 90° phase difference, traveling along optical paths 432 and 434 respectively. The reflected light pulse, is also split into two reflected light beams having a relative 90° phase difference, traveling along optical paths 436 and 438 respectively.

The output signals of the 4×4 coupler each have a 90° phase shift with respect to one another. Thus optical path 432 has an associated 0° phase shift, optical path 434 has an associated 90° phase shift, optical path 436 has an associated 180° phase shift and optical path 438 has an associated 270° phase shift. The first of the split reference signals, traveling along optical path 432, is combined with the first of the split reflected light signals, traveling along optical path 436, and are input to the first balanced receiver 440. The resulting output of the balanced receiver 440 is a first combined light beam traveling along optical path 446. First balanced receiver 440 removes the DC component of the first combined light beam.

Likewise, the second of the two split reference signals, traveling along optical path 434, is combined with the second of the two split reflected light signals, traveling along optical path 438. These are fed as input to the second of the two balanced receivers 442. The resulting output of the balanced receiver 442 is a second combined light beam traveling along optical path 448. Second balanced receiver 442 removes the DC component of the second combined light beam.

The first and second combined light beams, travelling along optical paths 446 and 448 respectively, each have the same frequency components but have a 90° relative phase different. Optical system outputs the first and second combined light beams that travel along optical paths 450 and 452.

In further embodiments, the optical coupler can be a 3×3 optical coupler that introduces 120° relative phase shifts. In further embodiments, an m×n coupler can be used.

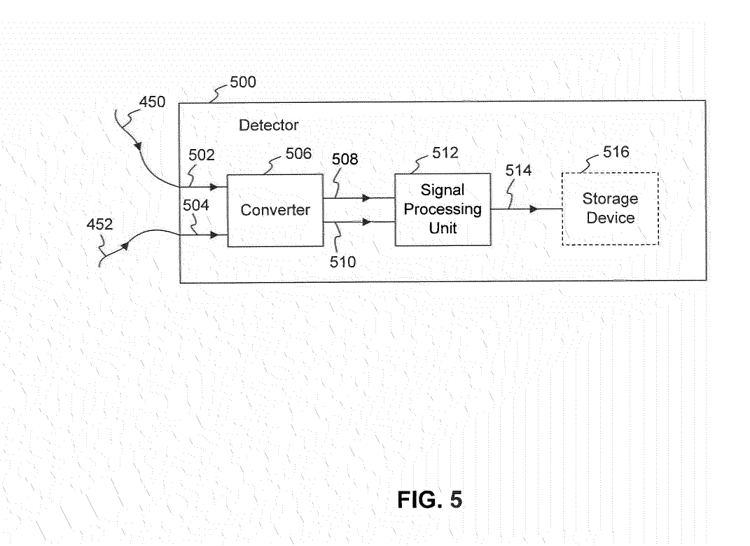

FIG. 5 illustrates an example detector 500, according to an embodiment of the present invention. For example, detector 500 could be used for detector 120 if FIG. 1, and can be bused with optical system 400B illustrated in FIG. 4B.

In one example, system 500 comprises a convertor 506, a signal processing unit 512, and an optional storage device 516.

In the example shown, light beams are input to the detector 500 as first and second light beams traveling along optical paths 450 and 452, and continue to travel to converter 506 along corresponding paths 502 and 504 In one example, convertor 506 converts the first and second light beams into first and second electronic signals 508 and 510 respectively.

First and second electronic signals 508 and 510 are input to signal processing unit 512. Signal processing unit 512 combines the first and second electronic signals 508 and 510 to produce a result signal 514. For example, result signal 514 is an electronic representation of a light pulse that has reflected from a target after effects due to phase noise and phase ambiguity have been removed. Signal processing unit 512 can be configured to remove phase ambiguity and effects due to phase noise by performing an in-phase and quadrature (IQ) algorithm on the first and second electronic signals 508 and 510, which have a 90° relative phase difference.

In an example embodiment, the signal processing unit 512 can carry out a square-and-sum algorithm of the following form:

R(t)={square root over ((f(t)²+g(t)²))},

where f(t) and g(t) are the first and second electronic signals, and R(t) is the result signal.

In another embodiment, the signal processing unit 512 can carry out a differential cross multiplier algorithm of the following form:

$$R ( t ) = f ( t ) \frac{d g ( t )}{d t} + \frac{d f ( t )}{d t} g ( t ) ,$$

where f (t) and g(t) are the first and second electronic signals,

$$\frac{d f ( t )}{d t} and \frac{d g ( t )}{d t}$$

are the time derivatives of the first and second electronic signals, and R(t) is the result signal.

In a further embodiment, the signal processing unit 512 can be configured to carry out a temporal standard deviation algorithm on a plurality of N pulses that are generated by the coherent source. The temporal standard deviation algorithm is of the form:

$${σ}_{x , t} = \sqrt{\frac{{\sum }_{i = 1}^{N} {( {y}_{i} ( x , t ) - \tilde{y} ( x , t ) )}^{2}}{N}} ,$$

where σ_{x,t} is the temporal standard deviation calculated for each specific distance x and time t, yᵢ(x, t) is a specific reflected pulse taken from the plurality of N pulses and y̅(x, t) is the average over all pulses in the plurality, and the computation of the average is done for each specific distance x and time t according to the algorithm:

$$\overline{y} ( x , t ) = \frac{{\sum }_{i = 1}^{N} {y}_{i} ( x , t )}{N} .$$

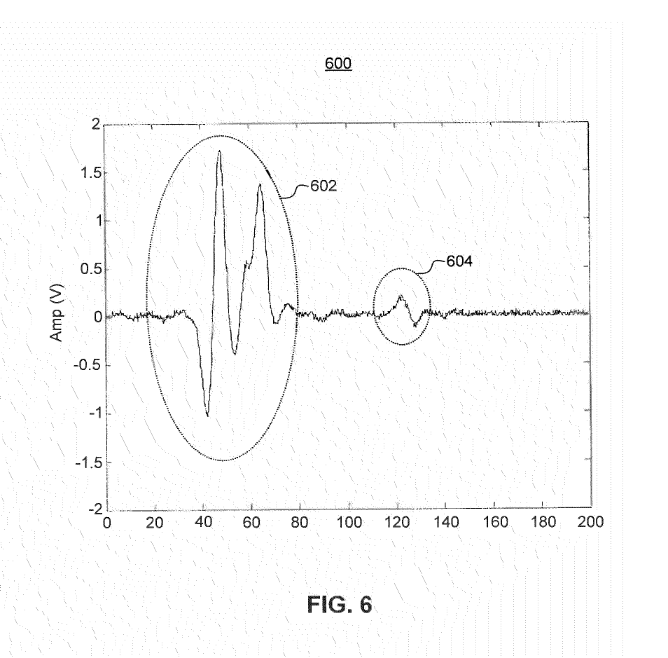

FIG. 6 illustrates a graph 600 with a pulse 602, according to an embodiment of the present invention. Pulse 602 represents a fraction of an initial light pulse. Referring again to FIG. 1, outgoing light pulse is primarily transmitted to the target region 108. However, some of the outgoing light pulse may be reflected back from optical components within the transceiver and be directed to optical system 118 detector 120. Once detected, this reflected light is represented as pulse 602.

In this example, pulse 604 represents a return pulse collected by the transceiver 104 that has been reflected back from the target 108.

In one example, a time difference between the pulses 602 and 604 gives rise to a measure of distance according to the formula:

$$D = \frac{c τ}{2} ,$$

where c is the speed of light and τ is the time difference. The factor of two accounts for the fact that the measured time corresponds to traversing the distance twice, once in traveling to and once in returning from the target.

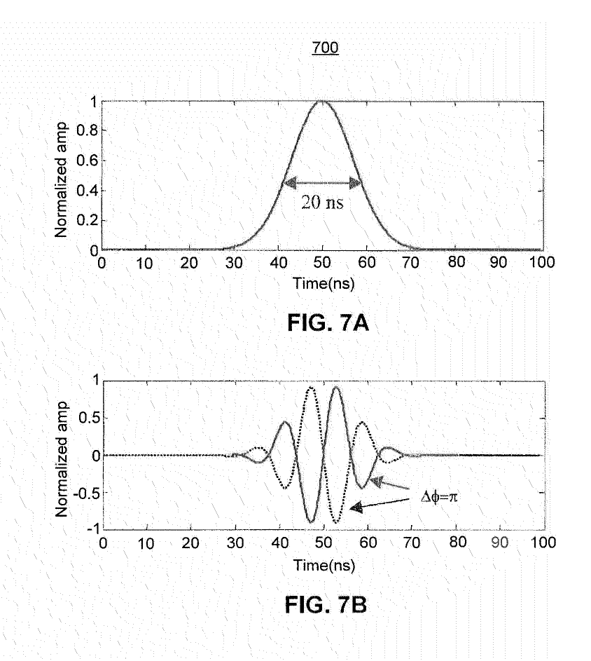

FIGS. 7A and 7B illustrate graphs 700A and 700B, according to embodiments of the present invention. For example, graphs 700A and 700B can illustrate phase uncertainty in a light beam.

In one example, an oscillatory peaks seen in pulse 602 of FIG. 6 are due to a phase of the pulse. FIG. 7B shows two different phase components of a pulse having the pulse envelope shown in FIG. 7A. In one example, the two different phase components shown in FIG. 7B correspond to first and second combined light beams 446 and 448 discussed with reference to FIG. 4B. In this example, each of the first and second combined light beams 446 and 448 have the same frequency components, but are different by a relative 90° phase shift. Using the embodiment of FIG. 4B, the phase components are removed by one of several algorithms discussed above. Using either the square-and-sum algorithm or the differential cross multiply algorithm removes the phase information and results in a single pulse as shown in FIG. 7A. Removing the phase information as shown in going from FIG. 7B to FIG. 7A improves the accuracy of distance measurement by removing the ambiguity as to where the peak of the pulse lies.

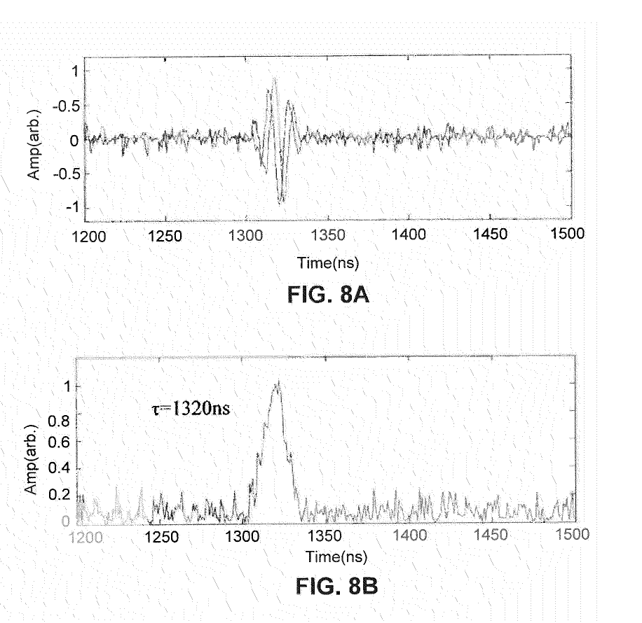

FIGS. 8A and 8B illustrate graphs 800A and 800B, according to embodiments of the present invention. For example, graphs 800A and 800B illustrate removing phase noise. In addition to the phase uncertainty related to the two phase components shown in FIG. 2B, typically there will be additional effects due to phase noise generated from random fluctuations in the environment. FIG. 8A shows a simulation of a pulse similar to the one shown in FIG. 7, but with the inclusion of random phase noise. FIG. 8B shows the result of using either the square-and-sum algorithm or the differential cross multiply algorithm, discussed above, applied to the signals of FIG. 8A. There is considerable improvement in the pulse shape of FIG. 8B. The pulse of FIG. 8B is well defined with reduced uncertainty as to the peak position.

In another embodiment, phase ambiguity and effects due to phase noise are removed by using a temporal standard deviation algorithm as discussed above. In this example rather than a single pulse, the source 102 generates a plurality of pulses comprising N pulses wherein N is a positive integer. The signal processing unit 512 can be configured to carry out a temporal standard deviation algorithm as discussed above.

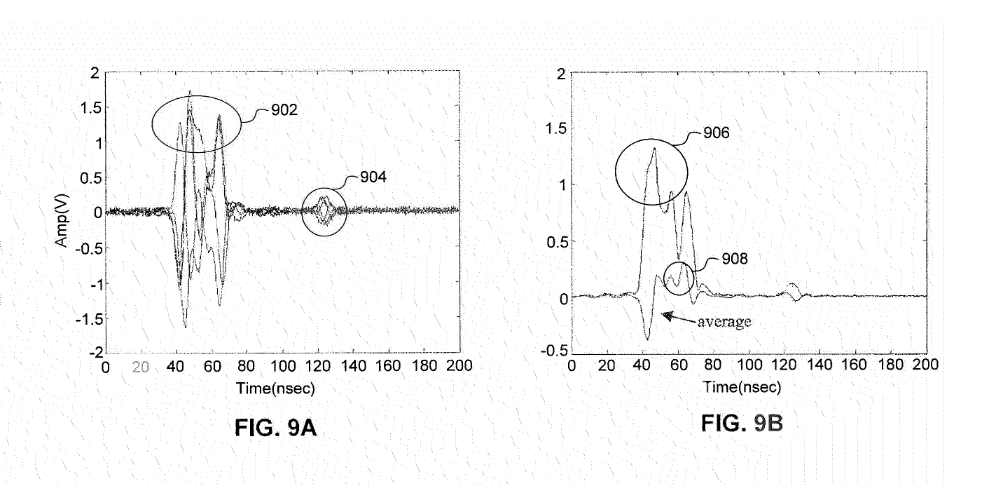

FIG. 9A illustrates a graph 900A, according to an embodiment of the present invention. For example, a pulse 902 represents a light beam that is launched at the target and the curve 904 represents a reflected back light beam, reflecting from the target. In this example, the initial pulse 902 comprises a plurality of pulses. The plurality of N pulses are launched in a time that is short compared to the time required for the pulse to travel to and be reflected back from the target.

An embodiment showing a result of carrying out the temporal standard deviation algorithm is illustrated in FIG. 9B. Signal 908 represents the average of all the pulses. The average of the plurality of pulses gives a small value. However, if one computes the standard deviation, one gets a well-defined pulse feature as indicated by 906.

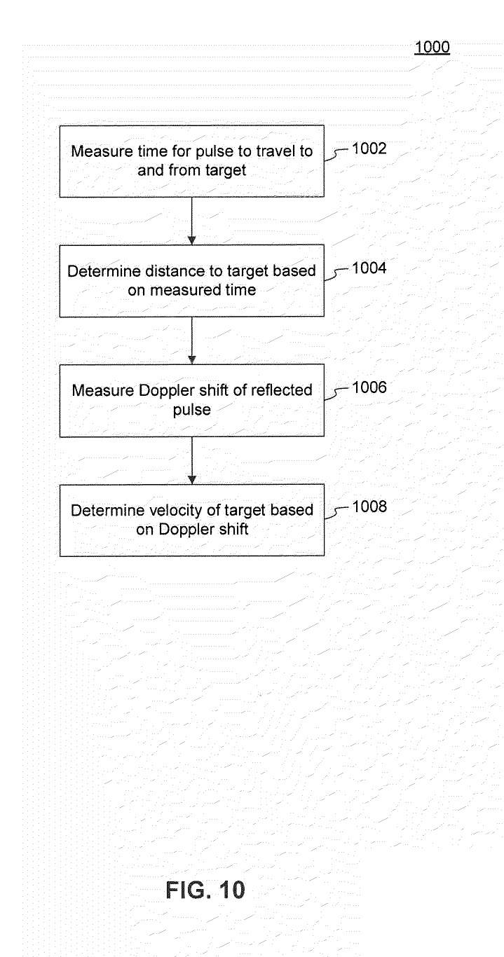

FIG. 10 illustrates a flowchart showing a method 1000, according to an embodiment of the present invention. For example, method 100 can be used to, measure distance and velocity of a target. In one example method 1000 can be carried out using the systems shown in FIGS. 1-6. It is to be appreciated that not all the steps shown may be performed, nor in the order shown.

In step 1002, the time for a pulse to travel to and from a target is measured. In step 1004, a distance to the target based on the measured time is determined. In step 1006, a Doppler shift of the reflected light pulse is measured. In step 1008 a velocity of the target is determined based on the Doppler shift.

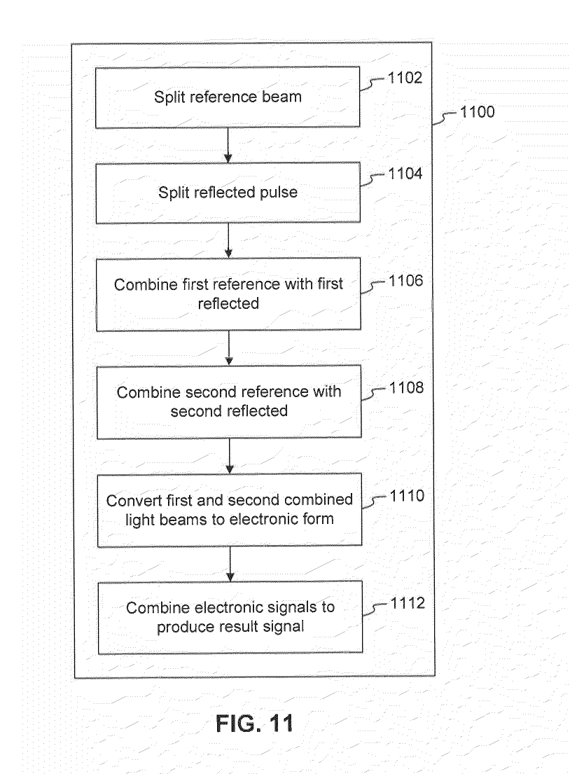

FIG. 11 is a flowchart illustrating a method 1100, according to an embodiment of the present invention. For example, method 1100 may be used as a refinement of steps 1002 or 1006 for measuring distance and velocity of a target. In one example, method 1100 employs techniques for removing phase ambiguity and effects due to phase noise. It is to be appreciated that not all the steps shown may be performed, nor in the order shown.

In step 1102, a reference beam is split into first and second reference beams. In general, the reference beam can be split by an m×n optical coupler where m and n are integers. In general, the m×n optical coupler is configured to split the reference light beam into first and second reference beams each having a relative phase difference with respect to another. In one embodiment, the optical coupler can be a 4×4 optical coupler that introduces 90° phase shifts with respect to various input signals. In another embodiment, the optical coupler can be a 3×3 optical coupler that introduces 120° phase shifts.

In step 1104, a reflected pulse is split using an m×n optical coupler into first and second reflected light beams. In one embodiment, the optical coupler can be a 4×4 coupler that introduces 90° phase shifts. In another embodiment, the optical coupler can be a 3×3 optical coupler that introduces 120° phase shifts.

In step 1106, the first reference beam is combined with the first reflected beam using a first balanced receiver.

In step 1108, the second reference beam is combined with a second reflected beam using a second balanced receiver.

In step 1110, first and second combined light beams are converted to first and second electronic signals.

In step 1112, the first and second electronic signals are combined to produce a result signal. In an example embodiment, electronic signals can be combined in step 1112 using a square-and-sum algorithm to remove phase ambiguity and effects due to phase noise. In another embodiment, electronic signals can be combined in step 1112 using a differential cross multiplier algorithm to remove phase ambiguity and effects due to phase noise. In a third embodiment, electronic signals can be combined in step 1112 using a temporal standard deviation algorithm. In this instance, the reflected pulse is comprised of a plurality of N pulses. Again the resulting signal is obtained by combining the electronic signals in step 1112 to generate a signal that represents the reflected light pulse after phase ambiguity and effects due to phase noise have been removed.

The Summary and Abstract sections may set forth one or more but not all exemplary embodiments of the present invention as contemplated by the inventors and are thus not intended to limit the present invention and appended claims in any way.

Various embodiments have been described above with the aid of functional building blocks illustrating the implementation of specific features and relationships thereof. The boundaries of these functional building blocks have been arbitrarily defined herein for the convenience of the description. Alternate boundaries can be defined so long as specific functions and relationships thereof are appropriately performed. The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above described exemplary embodiments.

What is claimed is:

1. A method comprising:
measuring a time required for a light pulse to travel to and from a target, the light pulse reflecting from the target;
determining a distance to the target based on the measuring;
measuring a Doppler shift of the reflected light pulse using an optical detection technique; and
determining a velocity of the target from the Doppler shift.

2. The method of claim 1, wherein the measuring further comprises:
splitting a reference light beam into first and second reference beams having a relative phase difference with respect to each other;
splitting the reflected light pulse into first and second reflected light beams having a relative phase difference with respect to each another;
combining respective ones of the first and second reference beams with corresponding ones of the first and second reflected light beams to produce first and second combined light beams;
converting the first and second combined light beams to corresponding first and second electronic signals; and
combining the first and second electronic signals to produce a result signal, whereby the result signal is an electronic representation of the reflected light pulse after phase ambiguity and effects due to phase noise have been removed.

3. The method of claim 2, wherein the relative phase difference is one of a 120 degree phase difference or a 90 degree phase difference.

4. The method of claim 2, wherein the splitting of the reference beam is performed using a 3×3 or 4×4 optical coupler.

5. The method of claim 2, wherein the combining comprises using an in-phase and quadrature algorithm comprising a square-and-sum algorithm or a differential cross multiplier algorithm.

6. The method of claim 2, wherein the combining comprises using a temporal standard deviation algorithm.

7. A system comprising:
a transceiver configured to receive a light pulse from a coherent source, transmit the light pulse to reflect from a target, and receive the reflected light pulse;
an optical system configured to receive the reflected light pulse and a reference light beam and to measure a Doppler shift of the reflected light pulse with respect to the reference light beam, and
a detector configured to measure a time for the light pulse to travel to and from the target and to determine a distance to the target based on the measured time, and to determine a velocity of the target from the Doppler shift.

8. The system of claim 7, wherein light propagates through the transceiver, the optical system, and the detector, via optical fibers.

9. The system of claim 7, further comprising:
a m×n optical coupler, wherein m and n are integers, configured to split the reference light beam into first and second split reference light beams each having a relative phase difference with respect to each another and to split the reflected light pulse into first and second split reflected light beams each having a relative phase difference with respect to each another;
first and second balanced receivers configured to combine respective ones of the first and second split reference light beams with corresponding ones of the first and second split reflected light beams to produce corresponding first and second combined light beams;
a converter configured to convert the first and second combined light beams to corresponding first and second electronic signals; and
a signal processing unit configured to combine the two or more electronic signals to produce a result signal, wherein the result signal is an electronic representation of the reflected light pulse after phase ambiguity and effects due to phase noise have been removed.

10. The system of claim 9, wherein light propagates among the various system components via optical fibers.

11. The system of claim 9, wherein the signal processing unit is configured to perform the combining using the following square-and-sum algorithm:
R(t)={square root over ((f(t)²+g(t)²))},
wherein f(t) and g(t) are the first and second electronic signals and R(t) is the result signal.

12. The system of claim 9, wherein the signal processing unit is configured to perform the combining using the following differential cross-multiplier algorithm:
$$R ( t ) = f ( t ) \frac{d g ( t )}{d t} + \frac{d f ( t )}{d t} g ( t ) ,$$
wherein f(t) and g(t) are the first and second electronic signals,
$$\frac{d f ( t )}{d t} and \frac{d g ( t )}{d t}$$
are the time derivatives of the first and second electronic signals and R(t) is the result signal.

13. The system of claim 9, wherein the m×n optical coupler comprises a 3×3 optical coupler configured to split a reference light beam into first and second split reference light beams having a relative 120 degree phase difference and to split a reflected light pulse into first and second split reflected light beams having a relative 120 degree phase difference, farther comprising:
a first receiver configured to combine the first split reference light beam with the first split reflected light beam to produce a first combined beam, wherein the first split reference light beam and the first split reflected light beam have a relative 120 degree phase difference;
a second receiver configured to combine the second split reference light beam with the second split reflected light beam to produce a second combined beam, wherein the second split reference light beam and the second split reflected light beam have a relative 120 degree phase difference;
a converter configured to convert the first and second combined beams to first and second electronic signals, wherein the first and second combined signals have a relative 120 degree phase difference; and
a signal processor configured to combine the first and second electronic signals to produce a result signal, wherein the result signal is an electronic representation of the reflected light pulse after phase ambiguity and effects due to phase noise have been removed.

14. The system of claim 9, wherein the m×n optical coupler comprises a 4×4 optical coupler configured to split a reference light beam into first and second split reference light beams having a relative 90 degree phase difference and to split a reflected light pulse into first and second split reflected light beams having a relative 90 degree phase difference, further comprising:
a first receiver configured to combine the first split reference light beam with the first split reflected light beam to produce a first combined beam, wherein the first split reference light beam and the first split reflected light beam have a relative 180 degree phase difference;
a second receiver configured to combine the second split reference light beam with the second split reflected light beam to produce a second combined beam, wherein the second split reference light beam and the second split reflected light beam have a relative 180 degree phase difference;
a converter configured to convert the first and second combined beams to first and second electronic signals, wherein the first and second combined signals have a relative 90 degree phase difference; and
a signal processor configured to combine the first and second electronic signals to produce a result signal, wherein the result signal is an electronic representation of the reflected light pulse after phase ambiguity and effects due to phase noise have been removed.

15. The system of claim 9, wherein the coherent source is further configured to generate a plurality of light pulses in a time short compared to the time required for the plurality of light pulses to travel to and from the target, and wherein the signal processing unit is further configured to carry out a temporal standard deviation algorithm to combine the plurality of reflected light pulses to produce a result signal.

16. The system of claim 15, wherein the plurality of pulses comprises N pulses (wherein N is a positive integer), and the signal processing unit is configured to perform the combining using the following temporal standard deviation algorithm:
$${σ}_{x , t} = \sqrt{\frac{{\sum }_{i = 1}^{N} {( {y}_{i} ( x , t ) - \overline{y} ( x , t ) )}^{2}}{N}} ,$$
where σ_{x,t} is the temporal standard deviation calculated for each specific distance x and time t, yᵢ(x, t) is a specific reflected pulse taken from the plurality of pulses and y̅(x, t) is the average over all pulses in the plurality computed for each specific distance x and time t according to the algorithm:
$$\overline{y} ( x , t ) = \frac{{\sum }_{i = 1}^{N} {y}_{i} ( x , t )}{N} .$$
